(19) United States
(12) Patent Application Publication
(10) Pub. No.: US 2022/0161423 A1
(43) Pub. Date: May 26, 2022

(54) Transformer-Based Meta-Imitation Learning Of Robots

(71) Applicants: NAVER CORPORATION, Gyeonggi-do (KR); NAVER LABS CORPORATION, Seongnam-si (KR)

(72) Inventors: Julien PEREZ, Grenoble (FR); Seungsu KIM, Meylan (FR); Theo CACHET, Grenoble (FR)

(73) Assignees: NAVER CORPORATION, Gyeonggi-do (KR); NAVER LABS CORPORATION, Seongnam-si (KR)

(21) Appl. No.: 17/191,264

(22) Filed: Mar. 3, 2021

Related U.S. Application Data
(60) Provisional application No. 63/116,386, filed on Nov. 20, 2020.

(51) Int. Cl. B25J 9/16; G06N 20/00

(52) U.S. Cl. CPC B25J 9/163; G06N 20/00

(57) ABSTRACT

A training system for a robot includes: a model having a transformer architecture and configured to determine how to actuate at least one of arms and an end effector of the robot; a training dataset including sets of demonstrations for the robot to perform training tasks, respectively; and a training module configured to: meta-train a policy of the model using first ones of the sets of demonstrations for first ones of the training tasks, respectively; and optimize the policy of the model using second ones of the sets of demonstrations for second ones of the training tasks, respectively, where the sets of demonstrations for the training tasks each include more than one demonstration and less than a first predetermined number of demonstrations.

### CROSS-REFERENCE TO RELATED APPLICATIONS

This application claims the benefit of U.S. Provisional Application No. 63/116,386, filed on 20 Nov. 2020. The entire disclosure of the application referenced above is incorporated herein by reference.

### FIELD

The present disclosure relates to robots and more particularly to systems and methods for training robots to be adaptable to performance of tasks other than training tasks.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Imitation learning may be promising to enable a robot to acquire competencies. Nonetheless, this paradigm may require a significant number of samples to become effective. One-shot imitation learning may enable robots to accomplish manipulation tasks from a limited set of demonstrations. This approach has shown encouraging results for executing variations of initial conditions of a given task without requiring task specific engineering. However, one-shot imitation learning may be inefficient for generalizing in variations of tasks involving different reward or transition functions.

### SUMMARY

In a feature, a training system for a robot includes: a model having a transformer architecture and configured to determine how to actuate at least one of arms and an end effector of the robot; a training dataset including sets of demonstrations for the robot to perform training tasks, respectively; and a training module configured to: meta-train a policy of the model using first ones of the sets of demonstrations for first ones of the training tasks, respectively; and optimize the policy of the model using second ones of the sets of demonstrations for second ones of the training tasks, respectively, where the sets of demonstrations for the training tasks each include more than one demonstration and less than a first predetermined number of demonstrations.

In further features, the training module is configured to meta-train the policy using reinforcement learning.

In further features, the training module is configured to meta-train the policy using one of the Reptile algorithm and the model-agnostic meta-learning (MAML) algorithm.

In further features, the training module is configured to meta-train the policy of the model before optimizing the policy.

In further features, the model is configured determine how to actuate at the least one of the arms and the end effector of the robot to advance toward or to completion of a task.

In further features, the task is different than the training tasks.

In further features, after the meta-training and the optimization, the model is configured to perform the task using less than or equal to a second predetermined number of user input demonstrations for performing the task, where the second predetermined number is an integer greater than zero.

In further features, the second predetermined number is 5.

In further features, the user input demonstrations include: (a) positions of joints of the robot; and (b) a pose of the end effector of the robot.

In further features, the pose of the end effector includes a position of the end effector and an orientation of the end effector.

In further features, the user input demonstrations also include a position of an object to be interacted with by the robot during performance of the task.

In further features, the user input demonstrations also include a position of a second object in an environment of the robot.

In further features, the first predetermined number is an integer less than or equal to ten.

In a feature, a training system includes: a model having a transformer architecture and configured to determine an action; a training dataset including sets of demonstrations for training tasks, respectively; and a training module configured to: meta-train a policy of the model using first ones of the sets of demonstrations for first ones of the training tasks, respectively; and optimize the policy of the model using second ones of the sets of demonstrations for second ones of the training tasks, respectively, where the sets of demonstrations for the training tasks each include more than one demonstration and less than a first predetermined number of demonstrations

In a feature a method for a robot includes: storing a model having a transformer architecture and configured to determine how to actuate at least one of arms and an end effector of the robot; storing a training dataset including sets of demonstrations for the robot to perform training tasks, respectively; meta-training a policy of the model using first ones of the sets of demonstrations for first ones of the training tasks, respectively; and optimizing the policy of the model using second ones of the sets of demonstrations for second ones of the training tasks, respectively, where the sets of demonstrations for the training tasks each include more than one demonstration and less than a first predetermined number of demonstrations.

In further features, the meta-training includes meta-training the policy using reinforcement learning.

In further features, the meta-training includes meta-training the policy using one of the Reptile algorithm and the model-agnostic meta-learning (MAML) algorithm.

In further features, the meta-training includes meta-training the policy of the model before optimizing the policy.

In further features, the model is configured determine how to actuate at the least one of the arms and the end effector of the robot to advance toward or to completion of a task.

In further features, the task is different than the training tasks.

In further features, after the meta-training and the optimization, the model is configured to perform the task using less than or equal to a second predetermined number of user input demonstrations for performing the task, where the second predetermined number is an integer greater than zero.

In further features, the second predetermined number is 5.

In further features, the user input demonstrations include: (a) positions of joints of the robot; and (b) a pose of the end effector of the robot.

In further features, the pose of the end effector includes a position of the end effector and an orientation of the end effector.

In further features, the user input demonstrations also include a position of an object to be interacted with by the robot during performance of the task.

In further features, the user input demonstrations also include a position of a second object in an environment of the robot.

In further features, the first predetermined number is an integer less than or equal to ten.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example robot;

FIG. 2 is a functional block diagram of an example training system;

FIG. 3 is a flowchart depicting an example method of training a model of a robot to perform tasks different than training tasks using only a limited set of demonstrations;

FIG. 4 is a functional block diagram of an example implementation of the model;

FIG. 5 is an example algorithm for training a model;

FIGS. 6 and 7 depict example attention values of the transformer-based policy at test time;

FIG. 8 includes a functional block diagram of an example implementation of an encoder and a decoder of the model;

FIG. 9 includes a functional block diagram of an example implementation of multi-head attention modules of the model; and

FIG. 10 includes a functional block diagram of an example implementation of the scaled dot-product attention modules of the multi-head attention modules.

In the drawings, reference numbers may be reused to identify similar and/or identical elements.

### DETAILED DESCRIPTION

Robots can be trained to perform tasks in various different ways. For example, a robot can be trained by an expert to perform one task via actuating according to user input to perform the one task. Once trained, the robot may be able to perform that one task over and over as long as changes in the environment or task do not occur. The robot, however, may need to be trained each time a change occurs or to perform a different task.

The present application involves meta-training a policy (function) of a model of a robot using demonstrations of training tasks. The policy is optimized using optimization based meta-learning using demonstrations of different tasks to configure the policy to be adaptable to performing tasks other than the training and test tasks using only a limited number (e.g., 5 or less) demonstrations of those tasks. Meta-learning may also be referred to as learning to learn, and may involve a training model to be able to learn new skills or adapt to new environments quickly with only the limited number of training examples (demonstrations). For example, given a collection of training tasks where each training task includes a small set of labeled data, and given a small set of labeled data from a test task, new samples from the test task can be labeled. The robot is then easily trainable, such as by a user, to perform multiple different tasks.

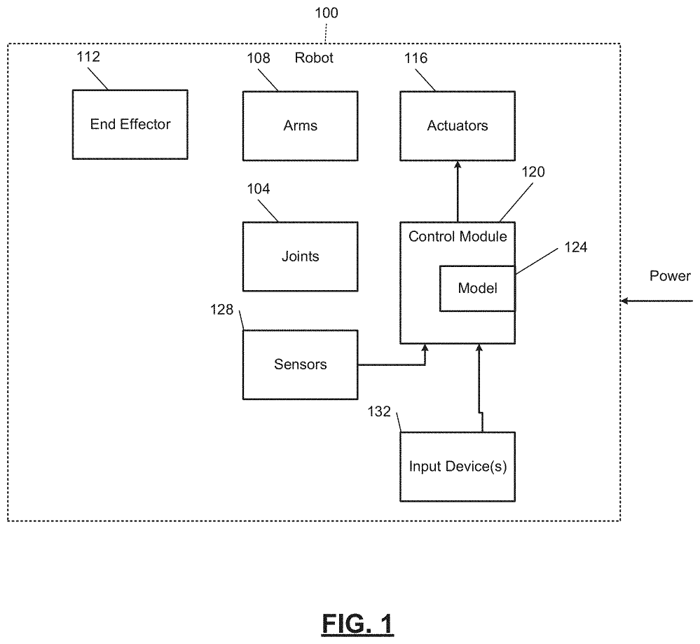

FIG. 1 is a functional block diagram of an example robot 100. The robot 100 may be stationary or mobile. The robot may be, for example, a 5 degree of freedom (DoF) robot, a 6 DoF robot, a 7 DoF robot, an 8 DoF robot, or have another amount of degrees of freedom.

The robot 100 is powered, such as via an internal battery and/or via an external power source, such as alternating current (AC) power. AC power may be received via an outlet, a direct connection, etc. In various implementations, the robot 100 may receive power wirelessly, such as inductively.

The robot 100 includes a plurality of joints 104 and arms 108. Each arm may be connected between two joints. Each joint may introduce a degree of freedom of movement of an end effector 112 of the robot 100. The end effector 112 may be, for example, a gripper, a cutter, a roller, or another suitable type of end effector. The robot 100 includes actuators 116 that actuate the arms 108 and the end effector 112. The actuators 116 may include, for example, electric motors and other types of actuation devices.

A control module 120 controls the actuators 116 and therefore the actuation of the robot 100 using a trained model 124 to perform one or more different tasks. An example of a task includes grasping and moving an object. The present application, however, is also applicable to other tasks. The control module 120 may, for example, control the application of power to the actuators 116 to control actuation. The training of the model 124 is discussed further below.

The control module 120 may control actuation based on measurements from one or more sensors 128, such as using feedback and/or feedforward control. Examples of sensors include position sensors, force sensors, torque sensors, etc. The control module 120 may control actuation additionally or alternatively based on input from one or more input devices 132, such as one or more touchscreen displays, joysticks, trackballs, pointer devices (e.g., mouse), keyboards, and/or one or more other suitable types of input devices.

The present application involves improving generalization ability of demonstration based learning to unknown/unseen/new tasks that are significantly different from the training tasks upon which the model 124 is trained. An approach is described to bridge the gap between optimization-based meta-learning and metric-based meta-learning for achieving task transfer in challenging settings. A transformer-based sequence-to-sequence policy network trained from limited sets of demonstrations may be used. This may be considered a form of metric-based meta-learning. The model 124 may be meta trained from a set of training demonstrations by leveraging optimization-based meta-learning. This may allow for efficient fine tuning of the model for new tasks. The model trained as described herein shows significant improvement relative to one-shot imitation approaches in various transfer settings and models trained in other ways.

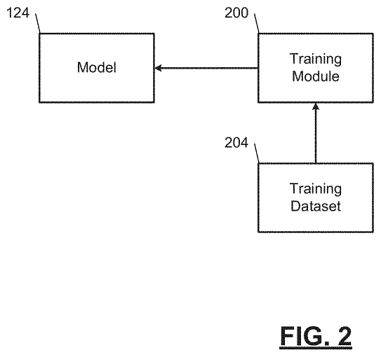

FIG. 2 is a functional block diagram of an example implementation of a training system. A training module 200 trains the model 124 as discussed further below using a training dataset 204. The training dataset 204 includes demonstrations for performing different training tasks, respectively. The training dataset 204 may also include other information regarding performing the training tasks. Once trained, the model 124 can adapt to perform tasks different than the training tasks using a limited number of demonstrations of a different, such as 5 demonstrations or less.

Robots are becoming more affordable and may therefore be used in more and more end-user environments, such as in residential settings to perform residential/household tasks. Robotic manipulation training may be performed by expert users in a fully specified environment with predefined and fixed tasks to accomplish. The present application, however, involves control paradigms where non-expert users can provide a limited number of demonstrations to enable the robot 100 to perform new tasks, which may be complex and compositional.

Reinforcement learning could be used in this regard. Safe and efficient exploration in a real environment, however, can be difficult, and a reward function can be challenging to set up in a real physical environment. As an alternative, a collection of training demonstrations are used by the training module 200 to train the model 124 such that it is efficiently able to perform different tasks using a limited number of demonstrations.

Demonstrations may have advantages to specify tasks. For example, demonstrations may be generic and can be used for multiple manipulation tasks. Second, demonstrations can be performed by end-users, which constitutes a valuable approach for designing versatile systems.

However, demonstration-based task learning may require a significant amount of system interaction to converge to a successful policy for a given task. One-shot imitation learning may help cope with these limitations and aims at maximizing the expected performance of the learned policy when faced with a new task defined only through a limited number of demonstrations. This approach of task learning is different than but can be considered related to metric-based meta-learning as, at testing time, the demonstrations of the possibly unseen task and the current state are matched in order to predict the best action at a given time-step. In this approach, the learned policy takes as input: (1) the current observation and (2) one or several demonstrations that successfully solves the target task. The policy is expected to achieve good performance without any additional system interaction, once the demonstrations are provided.

This approach may be limited to situations where there is only a variation of the parameters of the same task, like the initial position of the objects to manipulate. One example is the task of cube stacking where the initial and goal positions of each individual cube define a unique task. However, the model 124 should generalize on demonstrations of new tasks as long as the environment definitions are overlapping across the tasks.

The present application involves the training module 200 training the model 124 using a limited set of demonstrations is optimization-based meta-learning. Optimization based meta-learning produces an initialization of a policy to be efficiently fine-tuned on a test task from a limited amount of demonstrations. In this approach, the training module 200 trains the model 124 using an available collection of demonstrations associated with a set of training tasks (in the training dataset 204). In this case, the policy determines an action with respect to the current observation. At test time, the policy is fine-tuned using the available demonstrations of the target task. The parameter set of the fine-tuned model may need to fully capture the task.

The present application details the training module 200 training the model 124 to bridge a gap between metric-based and optimization based meta-learning to perform transfer across robotic manipulation tasks beyond the variation of the same task using a limited amount of demonstrations. First, the training involves a transformer-based model of imitation learning. Second, the training leverages optimization-based meta-learning to meta-train the model 124 using a few-shots and meta-imitation learning. The training described herein allows for efficient use of a small number of demonstrations while fine-tuning the model 124 to the target task. The model 124 trained as described herein shows significant improvement compared to one-shot-imitation framework in various settings. As an example, the model 124 trained as described herein may acquire 100% success on 100 occurrences of a completely new manipulation task with less than 15 demonstrations.

The model 124 is a transformer-based model (based on a transformer architecture) for efficiently learning end-user tasks based on less than a predetermined number of demonstrations (e.g., 5) provided by end-users. The model 124 is configured to perform metric-based meta-imitation learning to perform a different task from the limited set of user demonstrations. Described herein is a method to acquire and transfer basic skills to learn complex robotic arm manipulations based on demonstrations based on metric-based meta-learning and optimization-based meta-learning, which may execute the Reptile algorithm. The training described herein constitutes an efficient approach for end-user task acquisition in robotic arm control based on demonstrations. The approach allows the demonstrations to include (1) positions in the Euclidean space of the end effector 112, (2) the set of joint angle-position of the controlled arm(s), (3) the set of joint-torques of the controlled arm(s).

The training described herein is better than reinforcement learning (RL) at least in that RL may require a larger number of demonstrations to explore the targeted environment and may require specifying a reward function to define the task at hand. As consequences, RL is time consuming, computationally inefficient and defining a reward function can often be significantly more difficult (especially for end users) than providing demonstrations. Moreover, in a physical environment like robotic arms, defining a reward function for each task can be challenging. Beyond the definition of a task using the formalism of Markovian Decision Processes (MDP), a paradigm that allows an end-user to easily define a new task using a limited number of demonstrations is desirable.

Learning from demonstrations may not require exploration or unconditional availability of a reward function. The training described herein allows for efficient performance of task transfer in realistic environments. No user setup of the reward function is required. Exploration of the environment need not be performed. A limited number of demonstrations can be used to train the model 124 to perform a different task than one of the training tasks used to train the model 124. This enables a few-shot imitation learning model to successfully perform different tasks than the training tasks. The training module 200 may be implemented within the robot 100 as to perform the learning/training of the model 124 based on limited numbers of demonstrations from users in use of the robot 100.

The present application extends the one-shot imitation learning paradigm to meta-learning over a predefined set of tasks and fine-tuning end-user tasks based on demonstrations. The training discussed herein provides improvement over a one-shot imitation model by learning a transformer-based model for better use of demonstrations. In this sense, the training and the model 124 discussed herein bridges the gap between metric-based and optimization-based meta-learning.

Few-shot imitation learning considers the problem of acquiring skills to perform tasks using demonstrations of the targeted tasks. In the context of robotic manipulation, it is valuable to be capable of learning a policy to perform a task from a limited set of demonstrations provided by an end-user. Demonstrations from different tasks of the same environment can be learned jointly. Multi-task and transfer learning consider the problem of learning policies with applicability beyond a single task. Domain adaptation in computer vision and control allows acquisition of multiple skills faster than what it would take to acquire each of the skills independently. Sequential learning through demonstration may capture enough knowledge from previous tasks to accomplish a new task with only a limited set of demonstrations.

An attention based model (e.g., having the transformer architecture) may be applied over the considered demonstrations. The present application involves application of an attention model over the demonstrations and over the observation available from the current state.

Optimization-based meta-learning may be used to learn from small amounts of data. This approach aims at directly optimizing the model initialization using a collection of training tasks. This approach may assume access to a distribution over tasks, where each task is, for example, a robotic manipulation task involving different types of objects and purposes. From this distribution, this approach includes sampling a training set and a test set of tasks. The model 124 is fed the training dataset, and the model 124 produces an agent (policy) that has good performance on the test set after a limited amount of fine-tuning (training) operations. Since each task corresponds to a learning problem, performing well on a task corresponds to learning efficiently.

One meta-learning approach includes the learning algorithm being encoded in the weights of a recurrent network. Gradient descent may not be performed at test time. This approach may be used in long short term memory (LSTM) for next-step prediction and may be used in few-shot classification and for the partially observable Markov decision process (POMDP) setting. A second method, called metric-based meta learning, learns a metric to produce a prediction for a point with respect to a small collection of examples by matching the point with those examples using that metric. Imitation learning from demonstration, like one-shot imitation, can be associated with this method.

Another approach is to learn the initialization of a network, which is fine tuned at test time on the new task. An example of this approach is pre-training using a large dataset and fine-tuning on a smaller dataset. However, this pre-training approach may not guarantee learning an initialization that is good for fine-tuning, and ad-hoc adjustments may be required for good performance.

Optimization-based meta-learning may be used to directly optimize performance with respect to this initialization. A variant called Reptile which ignores the second derivative terms has also been developed. The Reptile algorithm avoids the problem of second-derivative computation at the expense of losing some gradient information but provides improved results. While the example of meta-training/learning involving use of the Reptile algorithm is provided, the present application is also applicable to other optimization algorithms, such as the model-agnostic meta-learning (MAML) optimization algorithm. The MAML optimization algorithm is described in Chelsea Finn, Pieter Abbeel, and Sergey Levine, “Model-agnostic meta-learning for fast adaptation of deep networks”, ICML, 2017, which is incorporated herein in its entirety.

The present application explains the benefits of optimization-based meta learning for few-shot imitation of sequential decision problems of robotic arm-control.

A goal of imitation learning may be to train a policy π of the model 124 that can imitate the behavior expressed in the limited set of demonstrations provided for performing a task. Two approaches to leveraging such data include inverse reinforcement learning and behavior cloning.

In the case of continuous action space, such as in robotic platforms, the training module 200 may train the policy with stochastic gradient descent to minimize a difference between demonstrated and learned behavior over its parameters θ.

As an extension to behavior cloning, one-shot imitation learning involves learning a meta-policy that can adapt to new, unseen tasks from a limited amount of demonstrations. The approach has originally been proposed to learn from a single trajectory of a target task. However this setting may be extended to few-shot learning if multiple demonstrations of the target task are available for training.

The present application may assume an unknown distribution of tasks p(τ) and a set of meta-training tasks {τᵢ} sampled therefrom. For each meta-training task τᵢ a set of demonstrations Dᵢ={d₁ⁱ, d₂ⁱ, . . . , d_{N}ⁱ} is provided. Each demonstration d is a temporal sequence of {observations; actions} tuples of successful behavior for that task dₙ=[(o₁ⁿ, a₁ⁿ, . . . (o_{T}ⁿ, a_{T}ⁿ)]. This meta-training demonstration can be produced in response to user input/actuation of the robot or heuristic policies in some examples. In a simulated environment, reinforcement learning may be used to create a policy from which trajectories can be sampled. Each task can include different objects and require different skills from the policy. The tasks can be, for example, reaching, pushing, sliding, grasping, placing, etc. Each task is defined by a unique combination of required skills, and the nature and positions of objects define a task.

One-shot imitation learning techniques learn a meta-policy π₀, which takes as input both the current observation oₜ and a demonstration d corresponding to the task to be performed, and outputs an action. The observation includes the current locations (e.g., coordinates) of the joints and the current pose of the end effector. Conditioning/training on different demonstrations can lead to different tasks being performed for the same observation.

During training, a task τᵢ is sampled, and two demonstrations dₘ and dₙ corresponding to this task are sampled/determined by the training module 200 to achieve the task. The two demonstrations may be selected based on the two demonstrations being the best suited for advancing toward to completion or completing the task. The meta-policy is trained by the training module 200 on one of these two demonstrations dₙ, and the following loss on the expert observation-action pairs from the other demonstration dₘ is optimized:

[symbol]

_{bv}={θ,dₘ,dₙ= [symbol] (aₜ^{m},π_{θ}(oₜ^{m},dₙ)),

where [symbol] is an action estimation loss function, such as an L² norm or another suitable loss function.

The one-shot imitation learning loss includes summing across all tasks and all possible corresponding demonstration pairs:

[symbol]

ₒₛᵢ(θ,{Dᵢ})=Σᵢ₌₁^{M}Σ_{d}_{ₘ}_{,d}_{ₙ}_{˜D}_{ᵢ} [symbol] _{bc}(θ,dₘ,dₙ),

where M is the total number of training tasks.

The present application involves combining two demonstrations related to each domain. First, the present application involves a few-shot imitation model based on a transformer architecture as a policy. Transformer architecture as used herein, and as used in the transformer architecture of the model 124, is described in Ashish Vaswani, Noam Shazeer, Niki Parmar, Jakob Uszkoreit, Llion Jones, Aidan N Gomez, [symbol] ukasz Kaiser, and Illia Polosukhin, “Attention is all you need”, In I. Guyon, U. V. Luxburg, S. Bengio, H. Wallach, R. Fergus, S. Vishwanathan, and R. Garnett, editors, Advances in Neural Information Processing Systems 30, pages 5998-6008, Curran Associates, Inc., 2017, which is incorporated herein in its entirety. Second, the present application involves optimizing the model using optimization based meta-training.

As stated above, the policy network of the model 124 is a transformer-based neural network architecture. The model 124 contextualizes input demonstrations using the multi-headed attention layers of the model 124 introduced in the transformer architecture. The architecture of the transformer network allows for better capturing of correspondences between the input demonstration and the current episode/observation. The transformer architecture of the model 124 may be pertinent to process the sequential nature of demonstrations of manipulation tasks.

The present application involves scaled dot-product attention and the transformer architecture for demonstration-based learning for robotic manipulation. The model 124 includes an encoder module and a decoder module. Both include stacks of multi-headed attention layers associated with batch normalization and fully connected layers. To adapt the model 124 for demonstration-based learning, the encoder takes as input the demonstration of the task to accomplish and the decoder takes as input all of the observations of the current episode.

By design, the transformer architecture does not have and does not use information of order when processing its input as all operators are commutative. While temporal encoding may be used, the present application involves a mixture of sinusoids with different periods and phases to each dimension of the input sequences. An action module determines the next action to perform based on the outputs of the encoder and decoder modules. The control module 120 actuates the robot 100 according to the next action.

The present application also involves optimization-based meta-learning to pre-train the policy network of the model 124 (e.g., in the action module). Optimization-based meta-learning pre-trains a set of parameters θ on a set of tasks τ to efficiently fine tune the policy network with a limited number of updates. That is: argmin_{θ} [symbol] _{τ}[L_{τ}(U_{τ}^{k}(θ))] with U_{τ}^{k} the operator that updates θ k times using data sampled from τ.

The operator U corresponds to performing gradient descent or Adam optimization on batches of data sampled from τ. Model-agnostic meta-learning solves the following problem: argmin_{θ} [symbol] _{τ}[L_{τ,J} (U_{τ,J}(θ))]. For a given task τ, the inner-loop optimization uses training samples taken from a task I and the loss is computed using samples taken from a task J. Reptile simplifies the approach by repeatedly sampling a task, training on it, and moving the initialization toward the trained weights on that task. Reptile is described in detail in Alex Nichol and John Schulman, “Reptile: a scalable metalearning algorithm”, arXiv: 1803.02999v1, 2018, which is incorporated herein in its entirety.

Training a policy that can be fine-tuned from demonstrations of an end-user task may fit particularly well with robotic arm control. The present application involves use of the Reptile optimization-based meta-learning algorithm across tasks defined by sets of demonstrations. The training dataset includes demonstrations for various tasks that are used to meta-train the model 124. As only a limited number of demonstrations are used to train the robot 100 to perform different tasks (e.g., during testing and/or in its end environment) the model 124 is trained such that it is efficiently fine-tunable from only the limited number of demonstrations, such as from end-users. The demonstrations are an input of the policy at test time.

As discussed above, first the policy of the model 124 is optimization based meta-trained using sets of training demonstrations for training tasks, respectively. Following the optimization-based meta-training, fine tuning of the policy is performed in two parts. A first set of the training tasks is kept for meta-training the policy and a second set of the training tasks are used for validation using early stopping.

The evaluation procedure includes fine-tuning the model 124 on each validation task and to compute [symbol] ₒₛᵢ over it. To perform a new task that is different than the training tasks, a limited set of demonstrations are provided to the control module 120. The limited set of demonstrations may be obtained in response to user input to the input devices 132 causing actuation of the arms 108 and/or the end effector 112. The limited set of demonstrations may be 5 demonstrations or less. As discussed above, each demonstration includes the coordinates of each joint and the pose of the end effector 112. The pose of the end effector 112 includes the position (e.g., coordinates) and orientation of the end effector. Each demonstration may also include other information regarding the new task to be performed, such as a position of an object to be manipulated by the robot 100, positions of one or more other relevant objects (e.g., objects to be avoided or relevant to the manipulation of the object), etc.

During this fine-tuning phase of the training, to extract as much information as possible from the limited set of demonstrations, the training module 200 optimizes the (previously meta-trained) model 124 by sampling among all available pairs of demonstrations. In the extreme of only one demonstration being available at test-time, the conditioning demonstration and the target demonstration are made the same.

During execution, if several demonstrations are available, they are processed in a batch and the expectation over actions are determined. In this sense, the model 124 can then be used in a few-shot manner. As a baseline, the training module 200 may use a multi-task learning algorithm, with or without task identification as input to maintain the same policy architecture. In this case, during training, the training module 200 samples demonstrations for the training and validation sets using the overall distributions of tasks of the training set.

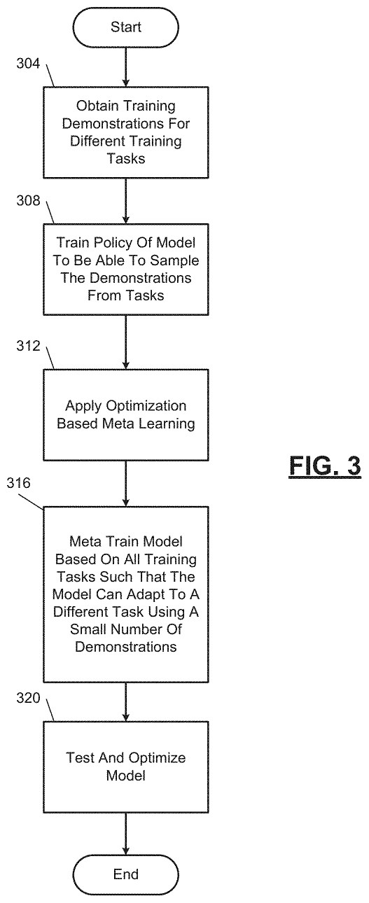

FIG. 3 is a flowchart depicting an example method of training the model 124 to be able to perform different tasks than the training tasks (and also the training tasks). Control begins with 304 where the training module 200 obtains the training demonstrations for performing each of the training tasks from the training dataset 204 in memory. The training tasks include meta-training tasks, validation tasks, and test tasks.

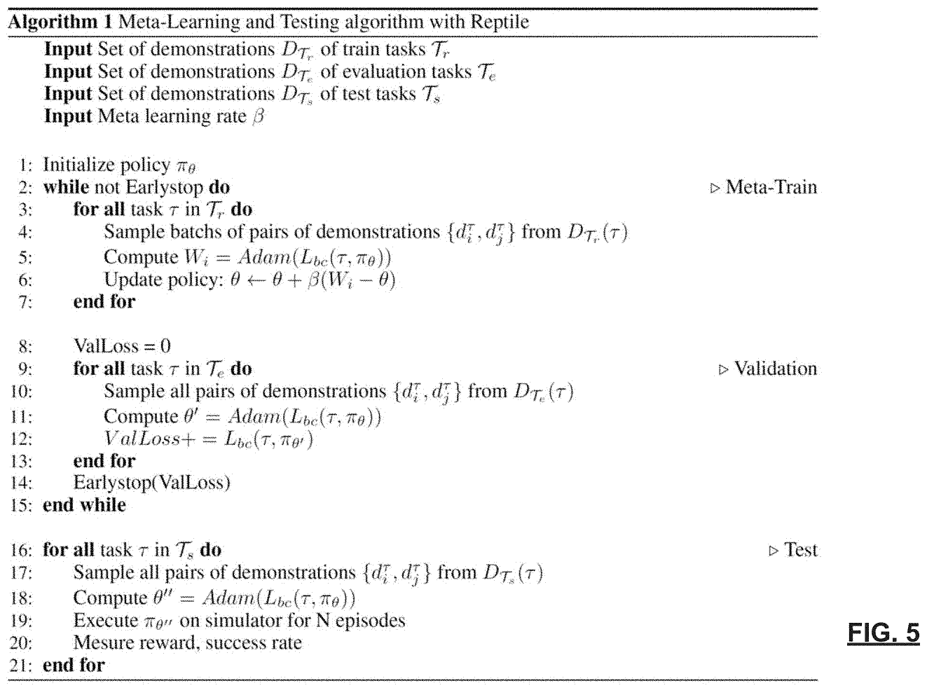

At 308, the training module 200 meta-trains the policy of the model 124 to be configured to sample demonstrations (e.g., user input demonstrations) for tasks. The model 124 can then determine pairs of demonstrations, as discussed above, to perform a task. As discussed above, the model 124 has the transformer architecture. The training module 200 may train the policy, for example, using reinforcement learning. At 312, the training module 200 applies optimization based meta-training to optimize the policy of the model 124. FIG. 5 includes a portion of example pseudo code for meta-training. As shown in FIG. 5, the meta-training involves, for each training task (T) in a training dataset (Tr), batches of pairs (e.g., all pairs) of training demonstrations for that task are selected and used to compute Wi, which is used to update the policy. This is performed for all of the training tasks.

The training module 200 may apply the optimization using the test demonstrations for the test tasks. The training module 200 may, for example, apply the Reptile algorithm or the MAML algorithm for the optimization.

At 316, the training module 200 meta-trains the policy of the model 124 based on all of the training tasks, such as for validation. FIG. 5 includes a portion of example pseudo code for validation. As shown in FIG. 5, the validation involves, for each validation task (T) in a validation dataset (Te), all pairs of validation demonstrations for that task are selected and used to compute θ′ and a loss Lbc. The loss Lbc for a task is added to a validation loss for the validation. This is performed for all of the training tasks. Early stopping may be performed based on the validation loss to prevent overfitting, such as when the validation loss changes by more than a predetermined amount.

The meta-training and validation enables the model 124 to adapt to and perform different tasks (than the training tasks) using a limited number (e.g., 5 or less) of demonstrations, such as user input demonstrations.

At 320, the training module 200 may test the model 124 using testing ones of the training tasks, which may be referred to as test tasks. The training module 200 may optimize the model 124 based on the testing. 316 and 320 of FIG. 3 are described in FIG. 5.

FIG. 5 includes a portion of example pseudo code for testing. For example, as shown in FIG. 5, the testing involves executing the trained and validated model 124 to perform test tasks. For a test task (T) in a test dataset (Ts), all pairs of test demonstrations for that test task are selected and used to compute θ′ and a loss Lbc reflecting the relative ability of the model 124 to perform the test task. The test tasks each include less than the predetermined number of demonstrations. Reward and success rate of the meta-trained and validated model 124 are determined by the training model 200. This is performed for all of the test tasks.

The meta-training, validation, and testing may be complete when the reward and/or success rate of the model 124 is greater than a predetermined value or a predetermined number of instances of meta-training, validation, and testing have been performed.

Once the meta-training and the optimization is complete, the model 124 can be used to perform tasks different than the training tasks with only a limited set of demonstrations, such as user input demonstrations/supervised training.

Examples of tasks include pushing involving displacing an object from an initial position to a goal position with the help of the end-effector of the controlled arm. Pushing includes manipulation tasks like pressing a button or closing a door. Reach is another task and includes displacing the position of the end-effector into a goal position. In some tasks, obstacles may be present in the environment. Pick and Place tasks involve grasping an object and displacing it in a goal position.

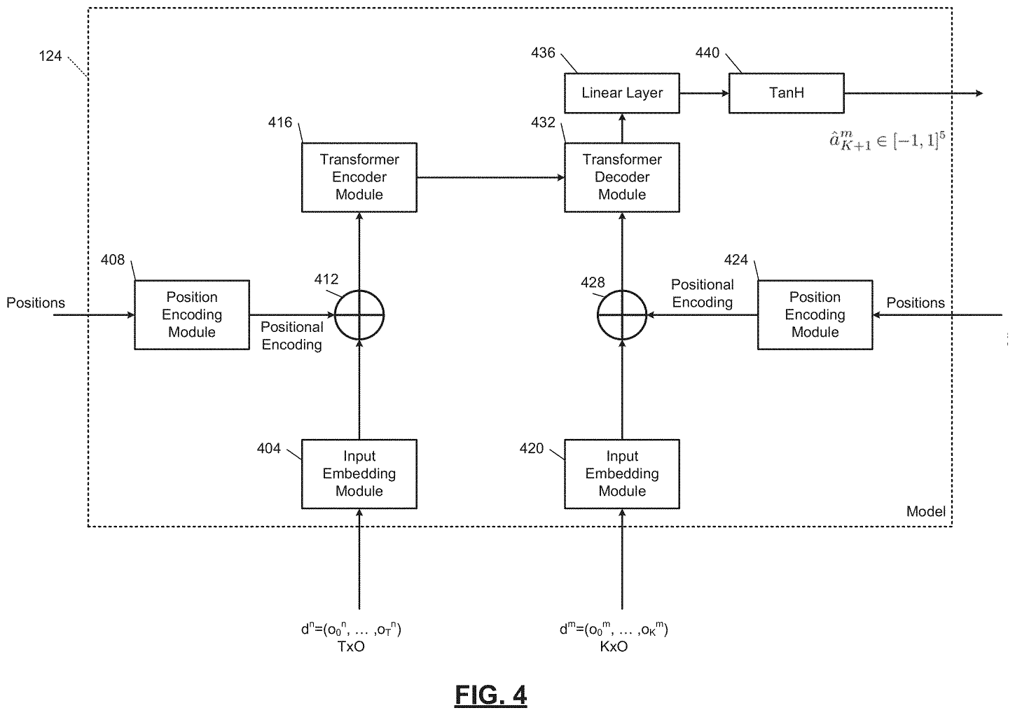

FIG. 4 is a functional block diagram of an example implementation of the transformer architecture of the model 124. The model 124 includes a multi-headed attention layer including h “heads” which are computed in parallel. Each of the heads performs three linear projections called (1) the key K=[t]_{1:T}W^{K}, (2) the query Q=[t]_{1:T}W^{Q} and (3) the value V=[t]_{1:T}W^{V} into dt dimensions:

headi=Att([t]1:TWᵢ^{Q},[t]1:TWᵢ^{K};[t]1:TWᵢ^{v})

for i={1, . . . , h} and [·]1:T is the row-wise concatenation operator, and where projections are parameter matrices such that Wᵢ^{q}, Wᵢ^{K}, Wᵢ^{V}∈R^{d×d}^{ₜ}

The three transformations of the individual set of input features are used to compute a contextualized representation of each of the input vectors. The scaled-dot attention applied on each head independently is defined as

$$Att ( Q , K , V ) = softmax ( \frac{{QK}_{T}}{\sqrt{{d}_{k}}} ) V$$

with the resulting vector defined in a dt-dimensional output space. Each head aims at learning different types of relationships among the input vectors and transform them. Then, the outputs of each layer are concatenated as head{1, h} and linearly projected to obtain a contextualized representation of each input, merging all information independently accumulated in each head into M:

M=MultiHeadAtt(Q,K,V)=[head]_{1:h},W_{O}

where W^{O}∈ [symbol] ^{h,d}^{ᵥ}^{×d}.

The heads of the transformer architecture allows discovery of multiple relationships between the input sequences. Examples of PPO parameters are provided below. The present application, however, is applicable to other PPO parameters and/or values.

| Hyper-parameter | Value |
|---|---|
| Clipping | 0.2 |
| Gamma | 0.99 |
| Lambda (GAE) | 0.95 |
| Batch size | 4096 |
| Epochs | 10 |
| Learning rate | 3e−4 |
| Learning rate schedule | Linear annealing |
| Gradient norm clipping | 0.5 |
| Entropy coef | 1e−3 |
| Vale coef | 0.5 |
| Num. linear layer | 3 |
| Hidden dimension | 64 |
| Activation function | TanH |
| Optimizer | Adam |

The observation and reward running means and variances may be used for normalization as a difference in performance in different environments may occur.

Examples of recurrent model parameters are provided below. The present application, however, is applicable to other recurrent model parameters.

| Hyper-parameter | value |
|---|---|
| Learning rate | 5e−4 |
| Batch size | 128 |
| Num. GRU layer | 3 |
| Hidden dimension | 256 |
| Activation function | TanH |
| Dropout | 0.2 |
| Optimizer | Adam |
| nbr parameters | 1 260 000 |

Example parameters of the transformer (transformer model parameters) architecture are provided below. The present application, however, is also applicable to other transformer model parameters and/or values.

| Hyper-parameter | value |
|---|---|
| Learning rate | 1e−4 |
| Num. head | 8 |
| Num. encoder layer | 4 |
| Num. decoder layer | 4 |
| Feedforward dim | 1024 |
| Batch size | 256 |
| Hidden dim | 64 |
| Activation function | ReLU |
| Dropout | 0.1 |
| Optimizer | AdamW |
| 12 regularization | 0.01 |
| nbr parameters | 1 320 000 |

Example meta-training parameters of the Reptile algorithm are provided below. The present application, however, is also applicable to parameters and/or values.

| Hyper-parameter | value |
|---|---|
| Meta-Ir | 1e−3 |
| Inner updates | 250 |
| Outer updates | 1000 |
| Optimizer | Adam |
| EarlyStopping | Yes |

In various implementations, early stopping may be used during the training, such as with respect to mean square error loss on the test/validation tasks.

Example meta-training, multi-task (hyper) parameters are provided below. The present application, however, to other parameters and/or values.

| Hyper-parameter | value |
|---|---|
| Single task updates | 250 |
| Train/Validation ratio | 0.8/0.2 |
| Optimizer | Adam |
| EarlyStopping | Yes |

The training module 200 may reset the optimizer state between the fit of each task, such as to avoid keeping an outdated optimization momentum.

FIG. 5 includes code of an example algorithm for three consecutive steps of the meta-learning and fine tuning algorithm described herein. First, with training tasks [symbol] ᵣ, the training module 200 meta-trains the policy of the model 124, such as using the Reptile algorithm over the set of training tasks. Second, with evaluation tasks [symbol] ₑ, the training module 200 uses early-stopping over validation tasks as regularization. In this setting, the training module 200 performs validation including fine-tuning the meta-trained model on each task individually and computing validation behavior loss. Finally, with test tasks [symbol] ₛ, the training module 200 tests the model 124 by fine-tuning the policy on corresponding demonstrations. In this portion of the training, the fine-tuned policy is evaluated in terms of accumulated reward and success rate by simulated episodes in an environment, such as a Meta-World environment.

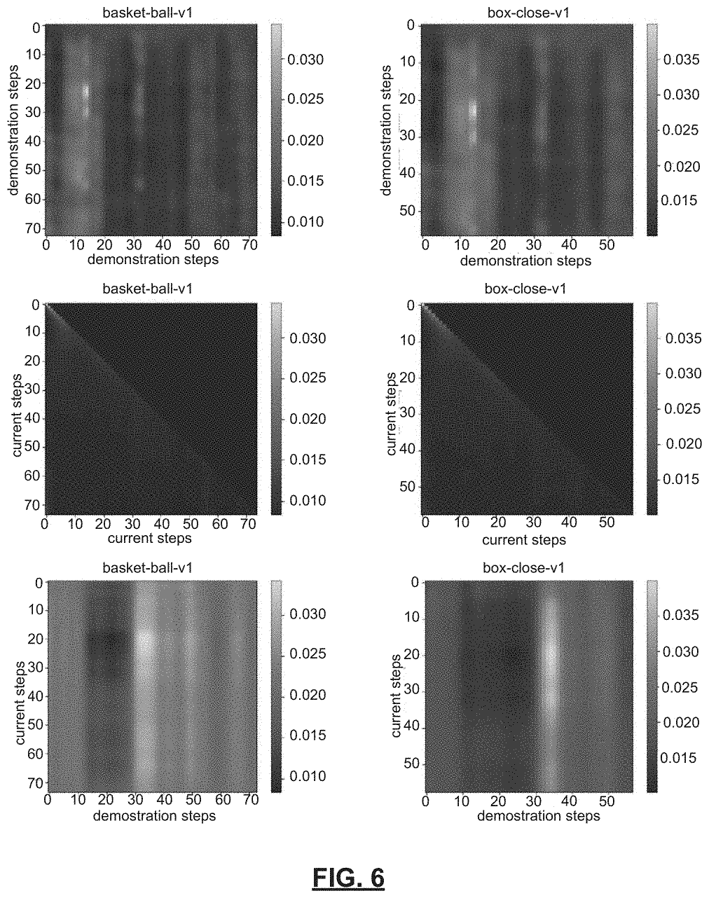

FIGS. 6 and 7 depict example attention values of the transformer-based policy at test time. The self-attention values of the first layer of the encoder which contextualize the input demonstration are shown first (top row). Shown second (middle row) are the self-attention values of the first layer of the decoder which contextualize the current episode. Shown third (bottom row) are the attention computed between the encoded representation of the demonstration and the current episode.

The encoder and decoder representation may represent different interaction schemas. The self-attention over the demonstration may capture important steps of the task at hand. High diagonal self-attention values are present when contextualizing the current episode. This may mean that the policy is trained to care more about recent observations than older ones. Most of the time the last 4 attentions values are the highest, which may be indicative of the model catching the inertia in the robotic-arm simulation.

From the last row, a vertical pattern of high attention values computed between the demonstration and the current episode can be seen. Those values may correspond to the steps of the demonstration requiring high skill and precision, like approaching the object, grasping and placing the object at the goal position, such as catching the ball in basket-ball-v1 in FIG. 6 or catching the peg in peg-unplug-side-0 in FIG. 7. The high value bands may fade vertically. This may be noticeable in the peg-unplug-side-0 example. This may mean that once the robot has caught the object, the challenging part of the task is done.

Referring back to FIG. 4, an input embedding module 404 embeds a demonstration (dₙ) using an embedding algorithm. Embedding may also be referred to as encoding. A position encoding module 408 encodes the present positions (e.g., the joints, the end effector, etc.) of the robot using an encoding algorithm to produce a positional encoding.

An adder module 412 adds the positional encoding to the output of the input embedding module 404. For example, the adder module 412 may concatenate the positional encoding on to a vector output of the input embedding module 404.

A transformer encoder module 416 may include a convolutional neural network and has the transformer architecture and encodes the output of the adder module 412 using a transformer encoding algorithm.

Similarly, an input embedding module 420 embeds a demonstration (dₘ) using an embedding algorithm, which may be the same embedding algorithm as that used by the input embedding module 404. The demonstrations dₘ and dₙ are determined by the training module 200 as described above. A position encoding module 424 encodes the present positions (e.g., the joints, the end effector, etc.) of the robot using an encoding algorithm to produce a positional encoding, such as the same encoding algorithm as the position encoding module 408. In this example, the position encoding module 424 may be omitted, and the output of the position encoding module 408 may be used.

An adder module 428 adds the positional encoding to the output of the input embedding module 420. For example, the adder module 428 may concatenate the positional encoding on to a vector output of the input embedding module 420.

A transformer decoder module 432 may include a convolutional neural network (CNN) and has the transformer architecture and decodes the output of the adder module 428 and the output of the transformer encoder module 416 using a transformer decoding algorithm. The output of the transformer decoder module 432 is processed by a linear layer 436 before a hyperbolic tangent (tanH) function 440 is applied. In various implementations, the hyperbolic tangent function 440 may be replaced with a softmax layer. The output is a next action to be taken to proceed toward or to completion of a task.

While the example of manipulation is described above, the present application is also applicable to other types of robotic tasks (other than manipulation) and non-robotic tasks.

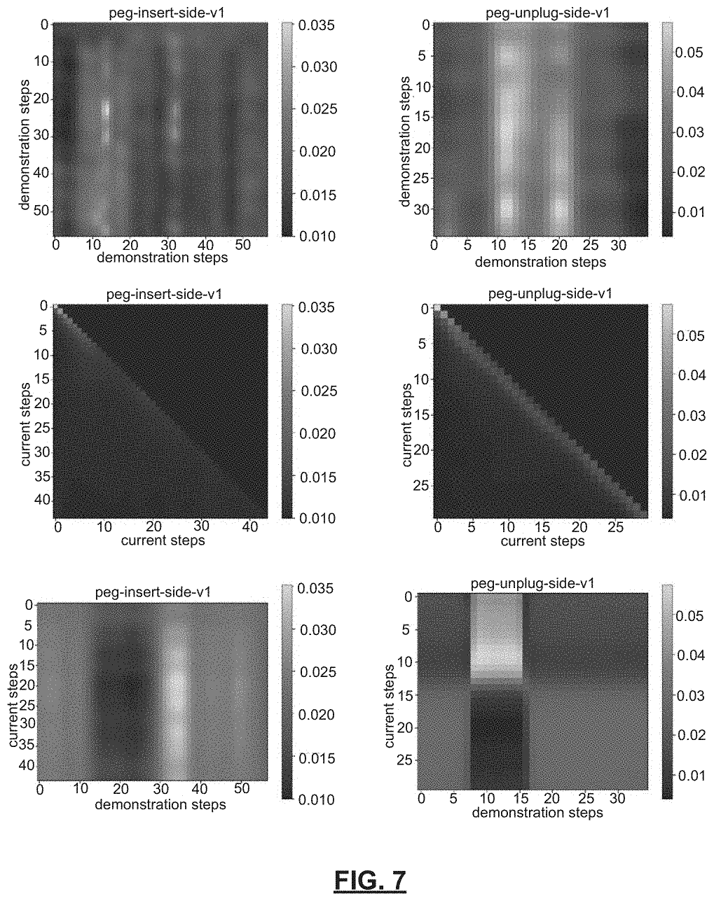

FIG. 8 is a functional block diagram of an example implementation of the transformer encoder module 416 and the transformer decoder module 432. The output of the adder module 412 is input to the transformer encoder module 416. The output of the adder module 428 is input to the transformer decoder module 432.

The transformer encoder 416 may include a stack of N=6 identical layers. Each layer may have two sub-layers. The first sub-layer may be a multi-head self-attention mechanism (module) 804, and the second may be a position wise fully connected feed-forward network (module) 808. Addition and normalization may be performed on the outputs of the multi-head attention module 804 and the feed forward module 808 by additional and normalization modules 812 and 816. Residual connections may be used around each of the two sub-layers, followed by layer normalization. That is, the output of each sub-layer is LayerNorm (x+Sublayer(x)), where Sublayer(x) is the function implemented by the sub-layer itself. To facilitate these residual connections, all sub-layers, as well as the embedding layers, may produce outputs of dimension d=512.

The transformer decoder module 432 may also include a stack of N=6 identical layers. Like the transformer encoder module 416, the transformer decoder module 432 may include a first sub-layer including a multi-head attention module 820 and a second sub-layer including a feed forward module 824. Addition and normalization may be performed on the outputs of the multi-head attention module 820 and the feed forward module 824 by additional and normalization modules 828 and 832. In addition to the two sub-layers, the transformer decoder module 432 may also include a third sub-layer, which performs multi-head attention (by a multi-head attention module 836) over the output of the transformer encoder module 416. Similar to the transformer encoder module 416, residual connections around each of the sub-layers followed by layer normalization. In other words, addition and normalization may also be performed on the output of the multi-head attention module 836 by an additional and normalization module 840. The self-attention sub-layer of the transformer decoder module 432 may be configured to prevent positions from attending to subsequent positions.

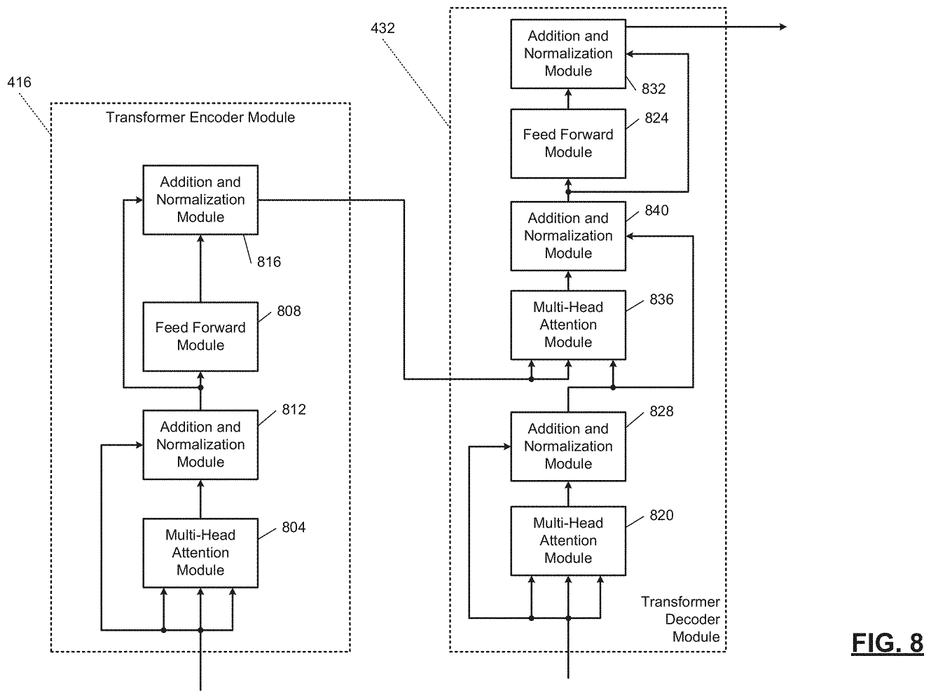

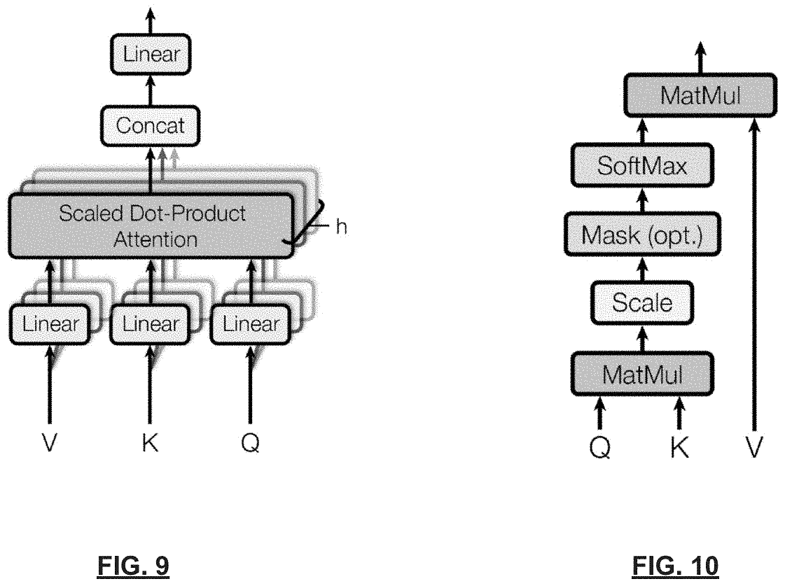

FIG. 9 includes a functional block diagram of an example implementation of the multi-head attention modules. FIG. 10 includes a functional block diagram of an example implementation of the scaled dot-product attention modules of the multi-head attention modules.

Regarding attention (performed by the multi-head attention modules), an attention function may be as mapping a query and a set of key-value pairs to an output, where the query, keys, values, and output are all vectors. The output may be computed as a weighted sum of the values, where the weight assigned to each value is computed by a compatibility function of the query with the corresponding key.

In the scaled dot-product attention module of FIG. 10, the input includes queries and keys of dimension dₖ, and values of dimension dᵥ. The scaled dot-product attention module computes dot products of the query with all keys, divides each by √dₖ, and applies a softmax function to obtain weights on the values.

The scaled dot-product attention module may compute the attention function on a set of queries simultaneously arranged in a matrix Q. The keys and values may also be held in matrices K and V. The scaled dot-product attention module compute the matrix of outputs as:

$$Attention ( Q , VK , V ) = softmax ( \frac{{QK}^{T}}{\sqrt{{d}_{k}}} ) V .$$

The attention function may be, for example, additive attention or dot-product (multiplicative) attention. Dot-product attention may be used in addition to scaling using a scaling factor of

$$\frac{1}{\sqrt{{d}_{k}}} .$$

Additive attention computes a compatibility function using a feed-forward network with a single hidden layer. Dot-product attention may be faster and more space-efficient than additive attention.

Instead of performing a single attention function with d-dimensional keys, values and queries, the multi-head attention modules may linearly project the queries, keys and values h times with different, learned linear projections to dₖ, dₖ and dᵥ, dimensions, respectively. On each of the projected versions of queries, keys, and values the attention function may be performed in parallel, yielding dᵥ-dimensional output values. These may be concatenated and projected again, resulting in the final values, as shown.

Multi-head attention allows the model to jointly attend to information from different representation subspaces at different positions. With a single attention head, averaging may inhibit this feature.

Multihead(Q,K,V)=Concat(head1, . . . ,headh)W^{O}, where headi=Attention(QWᵢ^{Q},KWᵢ^{K},VWᵢ^{V}),

where the projection parameters are matrices Wᵢ^{Q}∈ [symbol] ^{d×Q}, Wᵢ^{K}∈ [symbol] ^{d×d}^{ₖ}, Wᵢ^{V}∈ [symbol] ^{d×d}^{_{V}} and W^{O}∈ [symbol] ^{hd}^{ᵥ}^{×d}. h may be 8 parallel attention layers or heads. For each, dk=dv=d/h=64.

Multi-head attention may be used in different ways. For example, in the encoder-decoder attention layers, the queries come from the previous decoder layer, and the memory keys and values come from the output of the encoder. This may allow every position in the decoder to attend over all positions in the input sequence.

The encoder includes self-attention layers. In a self-attention layer all of the keys, values, and queries come from the same place, in this case, the output of the previous layer in the encoder. Each position in the encoder can attend to all positions in the previous layer of the encoder.

Self-attention layers in the decoder may be configured to allow each position in the decoder to attend to all positions in the decoder up to and including that position. Leftward information flow may be prevented in the decoder to preserve the auto-regressive property. This may be performed in the scaled dot-product attention by masking out (setting to 1) all values in the input of the softmax which may correspond to illegal connections.

Regarding the position wise feed forward modules, each may include two linear transformations with a rectified linear unit (ReLU) activation between.

FFN(x)=max(0; xW₁+b₁)W₂+b₂

While the linear transformations may be the same across different positions, they use different parameters from layer to layer. This may also be described as performing two convolutions with kernel size 1. The dimensionality of input and output may be d=512, and the inner-layer may have dimensionality d_{ff}=2048.

Regarding the embedding and softmax functions of the model 124, learned embeddings may be used to convert input tokens and output tokens to vectors of dimension d. The learned linear transformation and softmax function may be used to convert the decoder output to predicted next-token probabilities. The same weight matrix between the two embedding layers and the pre-softmax linear transformation may be used. In the embedding layers, the weights may be multiplied by \sqrt{d}.

Regarding the positional encoding, some information may be injected regarding relative or absolute position of the tokens in a sequence. Thus, the positional encodings may be added to the input embeddings at the bottoms of the encoder and decoder stacks. The positional encodings may have the same dimension d as the embeddings, so that the two can be added. The positional encodings may be, for example, learned positional encodings or fixed positional encodings. Sine and cosine functions of different frequencies:

PE_{(pos; 2i)}=sin(pos/10000^{2i/d})

PE_{(pos; 2i+1)}=cos(pos/10000^{2i/d})

where pos is the position and i is the dimension. Each dimension of the positional encoding may correspond to a sinusoid. The wavelengths form a geometric progression from 2π to 10000×2π. Additional information regarding the transformer architecture can be found in U.S. Pat. No. 10,452,978, which is incorporated herein in its entirety.

Few-shot imitation learning may refer to learning to complete a task given only a few demonstrations of successful completions of the task. Meta-learning may mean learning how to learn tasks efficiently using only a limited number of demonstrations. Given a collection of training task, each task includes a small set of labeled data. Given a small set of labeled data from a test task, new samples are from the test task distribution are labeled.

Optimization-based meta-learning may include optimization initialization of weights such that the weights perform well when fine-tuned using a small amount of data, such as in the MAML and Reptile algorithms. Metric-based meta-learning may include learning a metric such that tasks can be performed given a few training samples by matching new observations with the training samples using the metric.

Metric-based meta-learning (the terminology used in this ID), means learning a metric such that tasks can be solved given few training samples by matching new observations with those samples using that metric.

One-shot imitation learning involves a policy network taking as input a current observation and a demonstration and computing attention weights over the observation and demonstration. Next, the results are mapped through multi-layer perception to output an action. For training, a task is sampled and two demonstrations of the task are used to determine a loss.

The present disclosure involves the use of a transformer architecture including scaled dot-product attention units. Attention is computed over the observation history of the current episode and not just the current episode. The present application may involve training using the combination of optimization-based meta-learning, metric-based meta learning, and imitation learning. The present disclosure provides a practical way to combine multiple demonstrations at test time, such as by first fine-tuning then averaging over the actions given by attention to each of the demonstrations. The model trained as described herein performs better at test tasks (and real world tasks) that differ significantly from the training tasks than models trained differently. An example of differing tasks is tasks in different categories. Attention over the observation history may help in partially observed situations. The model trained as described herein may benefit from multiple demonstrations at test time. The model trained as described herein may also be more robust to suboptimal demonstrations than models trained differently.

The model as trained herein may render robots usable by non-experts and render robots trainable to perform many different tasks.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A training system for a robot, comprising:
a model having a transformer architecture and configured to determine how to actuate at least one of arms and an end effector of the robot;
a training dataset including sets of demonstrations for the robot to perform training tasks, respectively; and
a training module configured to:
meta-train a policy of the model using first ones of the sets of demonstrations for first ones of the training tasks, respectively; and
optimize the policy of the model using second ones of the sets of demonstrations for second ones of the training tasks, respectively,
wherein the sets of demonstrations for the training tasks each include more than one demonstration and less than a first predetermined number of demonstrations.

2. The training system of claim 1 wherein the training module is configured to meta-train the policy using reinforcement learning.

3. The training system of claim 1 wherein the training module is configured to meta-train the policy using one of the Reptile algorithm and the model-agnostic meta-learning (MAML) algorithm.

4. The training system of claim 1 wherein the training module is configured to meta-train the policy of the model before optimizing the policy.

5. The training system of claim 1 wherein the model is configured determine how to actuate at the least one of the arms and the end effector of the robot to advance toward or to completion of a task.

6. The training system of claim 5 wherein the task is different than the training tasks.

7. The training system of claim 5 wherein, after the meta-training and the optimization, the model is configured to perform the task using less than or equal to a second predetermined number of user input demonstrations for performing the task,
wherein the second predetermined number is an integer greater than zero.

8. The training system of claim 7 wherein the second predetermined number is 5.

9. The training system of claim 7 wherein the user input demonstrations include: (a) positions of joints of the robot; and (b) a pose of the end effector of the robot.

10. The training system of claim 9 wherein the pose of the end effector includes a position of the end effector and an orientation of the end effector.

11. The training system of claim 9 wherein the user input demonstrations also include a position of an object to be interacted with by the robot during performance of the task.

12. The training system of claim 11 wherein the user input demonstrations also include a position of a second object in an environment of the robot.

13. The training system of claim 1 wherein the first predetermined number is an integer less than or equal to ten.

14. A training system, comprising:
a model having a transformer architecture and configured to determine an action;
a training dataset including sets of demonstrations for training tasks, respectively; and
a training module configured to:
meta-train a policy of the model using first ones of the sets of demonstrations for first ones of the training tasks, respectively; and
optimize the policy of the model using second ones of the sets of demonstrations for second ones of the training tasks, respectively,
wherein the sets of demonstrations for the training tasks each include more than one demonstration and less than a first predetermined number of demonstrations.

15. A training method for a robot, comprising:
storing a model having a transformer architecture and configured to determine how to actuate at least one of arms and an end effector of the robot;
storing a training dataset including sets of demonstrations for the robot to perform training tasks, respectively;
meta-training a policy of the model using first ones of the sets of demonstrations for first ones of the training tasks, respectively; and
optimizing the policy of the model using second ones of the sets of demonstrations for second ones of the training tasks, respectively,
wherein the sets of demonstrations for the training tasks each include more than one demonstration and less than a first predetermined number of demonstrations.

16. The training method of claim 15 wherein the meta-training includes meta-training the policy using reinforcement learning.

17. The training method of claim 15 wherein the meta-training includes meta-training the policy using one of the Reptile algorithm and the model-agnostic meta-learning (MAML) algorithm.

18. The training method of claim 15 wherein the meta-training includes meta-training the policy of the model before optimizing the policy.

19. The training method of claim 15 wherein the model is configured determine how to actuate at the least one of the arms and the end effector of the robot to advance toward or to completion of a task.

20. The training method of claim 19 wherein the task is different than the training tasks.

21. The training method of claim 19 wherein, after the meta-training and the optimization, the model is configured to perform the task using less than or equal to a second predetermined number of user input demonstrations for performing the task,
wherein the second predetermined number is an integer greater than zero.

22. The training method of claim 21 wherein the second predetermined number is 5.

23. The training method of claim 21 wherein the user input demonstrations include: (a) positions of joints of the robot; and (b) a pose of the end effector of the robot.

24. The training method of claim 23 wherein the pose of the end effector includes a position of the end effector and an orientation of the end effector.

25. The training method of claim 23 wherein the user input demonstrations also include a position of an object to be interacted with by the robot during performance of the task.

26. The training method of claim 25 wherein the user input demonstrations also include a position of a second object in an environment of the robot.

27. The training method of claim 15 wherein the first predetermined number is an integer less than or equal to ten.
